(19) United States
(12) Patent Application Publication
(10) Pub. No.: US 2026/0341052 A1
(43) Pub. Date: Oct. 29, 2026

(54) Method and Analysis Device for Identifying Microorganism

(71) Applicants: SHIMADZU CORPORATION, Kyoto-shi (JP); JUNTENDO EDUCATIONAL FOUNDATION, Tokyo (JP)

(72) Inventors: Kanae TERAMOTO, Kyoto-shi (JP); Takao NAITO, Tokyo (JP); Yoko TABE, Tokyo (JP); Satomi TAKEI, Tokyo (JP)

(21) Appl. No.: 19/656,606

(22) Filed: Apr. 23, 2026

(30) Foreign Application Priority Data
Apr. 28, 2025 (JP) 2025-074073

(51) Int. Cl. G06V 20/69; G06V 10/26; G06V 10/44; G06V 10/72; G06V 10/75; G06V 10/764; G06V 10/774; G06V 10/82

(52) U.S. Cl. CPC G06V 20/695; G06V 10/26; G06V 10/44; G06V 10/72; G06V 10/75; G06V 10/764; G06V 10/774; G06V 20/698; G06V 10/82

(57) ABSTRACT

A method includes: a step of creating first target images that are images obtained by extracting, from the target image, portions corresponding to colonies; a step of creating second target images obtained by dividing the target image; a step of obtaining a first estimation result by applying the first target images to a first estimation model for estimating a type of microorganism; a step of obtaining a second estimation result by applying the second target images to a second estimation model for identifying a type of microorganism; a step of calculating a first ratio that is a ratio of type of microorganism included in the first estimation result; a step of calculating a second ratio that is a ratio of type of microorganism included in the second estimation result; and a step of identifying an analysis-target microorganism based on the first ratio and the second ratio.

### CROSS REFERENCE TO RELATED APPLICATIONS

This nonprovisional application is based on Japanese Patent Application No. 2025-074073 filed on Apr. 28, 2025 with the Japan Patent Office, the entire contents of which are hereby incorporated by reference.

### BACKGROUND OF THE INVENTION

### Field of the Invention

The present disclosure relates to a method and an analysis device each for identifying a microorganism.

### Description of the Background Art

In the field of microorganism identification, various techniques, such as Gram stain, biochemical characterization, and MALDI-MS, have been developed; however, a skilled laboratory technician may be able to estimate a type of microorganism by observing the appearance of the microorganism cultured on a solid media. However, it is difficult to secure such skilled laboratory technicians in all the microorganism identification sites.

Each of the preceding researches by Fan Yang et al., “Microbial Colony Detection Based on Deep Learning”, Applied Sciences, 2023, 13, 10568, https://doi.org/10.3390/app131910568, and Osamu Hasegawa, et al., “Detection of Microbial Colonies Isolated from Foods and Estimation of Species by Machine Learning”, Aichi Center for Industry and Science Technology, Research Report 2021, p. 74-77, discloses a technique in which a machine learning model is created based on an image of a microorganism cultured on a solid medium, and an analysis-target microorganism is identified using the machine learning model. Regarding the creation of the machine learning model, there is disclosed a technique in which an image of a solid medium on which a learning-target microorganism is cultured is acquired and divided, and a portion corresponding to a colony in each of the divided images is extracted and learned.

### SUMMARY OF THE INVENTION

However, there are various types of microorganisms, and appearances thereof on a solid medium also varies. Therefore, there has been required a method by which types of microorganisms having various appearances can be identified with high precision.

The present disclosure has been made to solve such a problem, and has an object to provide a method by which types of microorganisms having various appearances can be identified with high precision.

A first implementation of the present disclosure is directed to a method for identifying a microorganism, the method including: acquiring a target image that is an image of a solid medium on which an analysis-target microorganism is cultured; creating first target images that are images obtained by extracting, from the target image, portions corresponding to colonies; creating second target images obtained by dividing the target image into a plurality of images; obtaining a first estimation result by applying the first target images to a first estimation model for estimating a type of microorganism; obtaining a second estimation result by applying the second target images to a second estimation model for identifying a type of microorganism; calculating a first ratio that is a ratio of the type of microorganism included in the first estimation result; calculating a second ratio that is a ratio of the type of microorganism included in the second estimation result; and identifying the analysis-target microorganism based on the first ratio and the second ratio. The first estimation model is a model trained by using, as training data, a set of first learning images and a type of microorganism serving as a ground truth, the first learning images being images obtained by extracting, from a learning image, portions corresponding to colonies, the learning image being an image of a solid medium on which a learning-target microorganism is cultured. The second estimation model is a model trained by using, as training data, a set of second learning images and the type of microorganism serving as the ground truth, the second learning images being obtained by dividing the learning image into a plurality of images.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a configuration of an analysis device according to an embodiment.

FIG. 2 is a diagram for illustrating a relation between learning data and a machine learning model.

FIG. 3 is a diagram for illustrating a neural network.

FIG. 4 is a flowchart showing processes of creating first and second estimation models according to the embodiment.

FIG. 5 is a diagram for illustrating the process of creating the first estimation model according to the embodiment.

FIG. 6 is a diagram for illustrating the process of creating the second estimation model according to the embodiment.

FIG. 7 is a flowchart showing a microorganism identification process according to the embodiment.

FIG. 8 is a diagram for illustrating processes of creating first and second target images in an example.

FIG. 9 is a diagram showing first and second estimation results in the example.

FIG. 10 is an exemplary type of microorganism exhibiting a gradation pattern.

FIG. 11 is an exemplary type of microorganism with a huge colony size.

FIG. 12 is a diagram for illustrating a colony size calculation process according to a modification.

### DESCRIPTION OF THE PREFERRED EMBODIMENTS

Hereinafter, embodiments of the present invention will be described in detail with reference to figures. It should be noted that in the description below, the same or corresponding portions in the figures are denoted by the same reference characters, and will not be described repeatedly in principle.

### 1. Configuration of Analysis Device

FIG. 1 is a diagram showing a configuration of an analysis device 100 according to an embodiment. With reference to FIG. 1, analysis device 100 includes a controller 101, a display 15, and an operation unit 14. Controller 101 is connected to display 15 and operation unit 14. Operation unit 14 is typically constituted of a touch panel, a keyboard, a mouse, and the like. Operation unit 14 receives a user's operation input to a processor 10. Display 15 is constituted of, for example, a liquid crystal panel configured to display an image. Display 15 displays an image related to reception of the user's operation input, and displays a result of processing by processor 10.

Controller 101 has processor 10, a memory 11, a communication interface (I/F) 12, and an input/output I/F 13 as main components. These units are communicably connected to each other via a bus.

Processor 10 is typically an arithmetic processing unit such as a CPU (Central Processing Unit) or an MPU (Micro Processing Unit). Processor 10 controls an operation of analysis device 100 by reading and executing a program stored in memory 11. The program includes a program that, when executed by a computer, causes the computer to perform the method for identifying the microorganism according to the embodiment.

In the present specification, the microorganism identification includes discriminating a type of microorganism. The type of microorganism is generally defined by a phylogenetic classification (for example, scientific name, genus name, species name, subspecies name, or the like). The discrimination of the type of microorganism includes distinguishing it from the other types of microorganisms, and phylogenetically classifying the microorganism.

Memory 11 is implemented by a storage device such as a ROM (Read Only Memory), a RAM (Random Access Memory), or an HDD (Hard Disk Drive). The ROM can store a program to be executed by processor 10. The RAM can temporarily store data to be used during the execution of the program by processor 10, and can function as a temporary data memory used as a work area. The HDD is a nonvolatile storage device. A semiconductor memory device such as a flash memory may be employed in addition to or instead of the HDD. It should be noted that the program and/or the data may be stored in an external storage device accessible by processor 10.

Communication I/F 12 is a communication interface for exchanging various data with an external device, and is implemented by an adapter, a connector, or the like. It should be noted that a communication method may be a wireless communication method using a wireless LAN (Local Area Network) or the like, or may be a wired communication method using a USB (Universal Serial Bus) or the like.

Input/output I/F 13 is an interface for exchanging various data between processor 10 and an external device connected to input/output I/F 13. The external device includes operation unit 14 and display 15. An imaging device 16 may be connected to input/output I/F 13.

Imaging device 16 is a device for acquiring an image of a solid medium on which a microorganism is cultured, such as a camera.

The solid medium is typically an agar medium plate including agar, water, and a nutrient included for culture of a microorganism. The agar medium plate is produced by introducing a liquid-form agar medium into a round shallow container, which is called a petri dish or a petri plate, and cooling it. Hereinafter, in the present specification, the round shallow container will be referred to as “petri dish”. Generally, in the culture of a microorganism, a petri dish having a diameter of several cm (10 cm or less), which saves a space and is easy to handle, is frequently used.

It should be noted that analysis device 100 does need to be constituted of one computer, and may be constituted of a plurality of computers.

### 2. Relation Between Learning Data According to Embodiment and Machine Learning Model

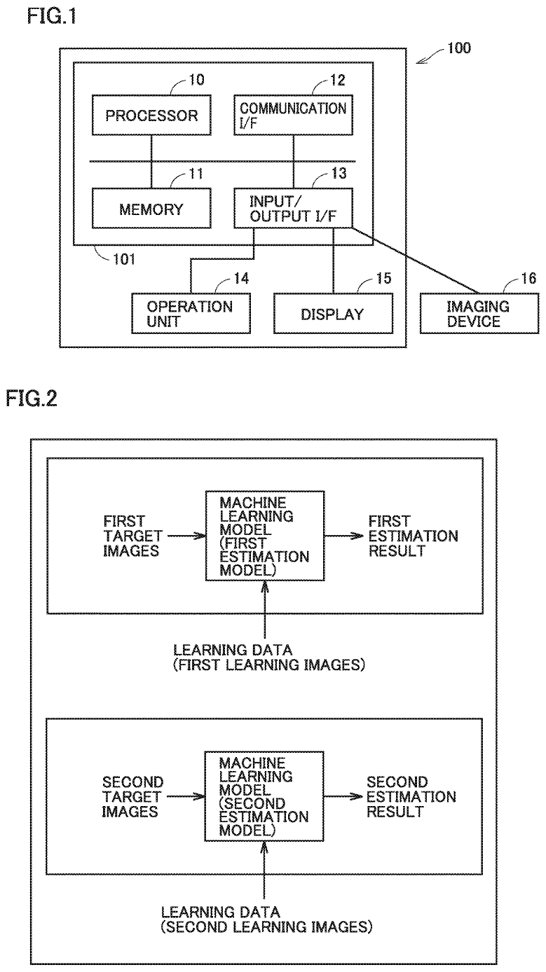

FIG. 2 is a diagram for illustrating a relation between learning data and a machine learning model according to the embodiment. Two machine learning models (first and second estimation models) used in the embodiment output estimation results (first and second estimation results) for two types of microorganisms when two types of target images (first and second target images) created from an image of a solid medium on which an analysis-target microorganisms is cultured are input thereto, respectively. Thus, each of the machine learning models can estimate a type of microorganism corresponding to the target image.

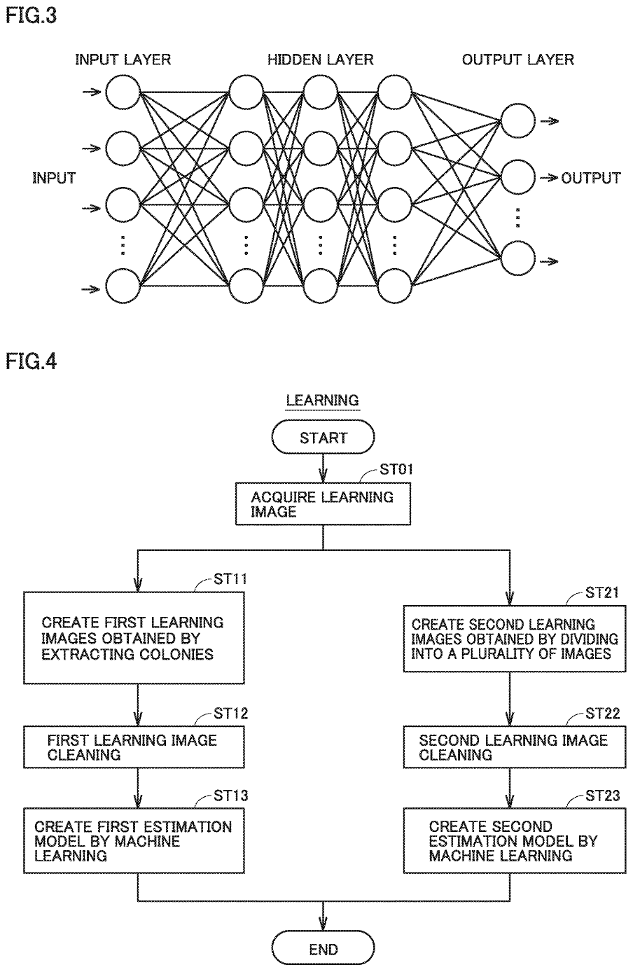

Such a machine learning model includes, for example, a neural network (FIG. 3). In the neural network, each node is weighted for an appropriate output in response to an input. The weighting is determined by learning using learning data.

More specifically, in the neural network, when a plurality of inputs are provided to an input layer, each input is multiplied by a weight in the input layer, and its multiplication result is sent to the next layer. In the next layer, the multiplication result is multiplied by a weight, and its multiplication result is further sent to the next layer. Finally, an output is obtained from an output layer.

The learning of the machine learning model is performed as follows, for example. First, two types of learning images (first and second learning images), which are images of a solid medium on which a microorganism for which its classification is known is cultured, are acquired. Next, the two types of machine learning models are learned using, as learning data, a set of the two types of learning images (first and second learning images) that are inputs of the machine learning models and a type of microorganism that should be an output (ground truth) in response to the inputs. Thus, each of the machine learning models learns to output an output that should be output in response to an input. In the example of FIG. 3, the weighting of each node is appropriately adjusted.

### 3. Method for Creating Learning Data According to Embodiment

FIG. 4 is a flowchart showing processes of creating learning data according to the embodiment. Each step (hereinafter, also referred to as “ST”) shown in FIG. 4 is performed by processor 10 of analysis device 100.

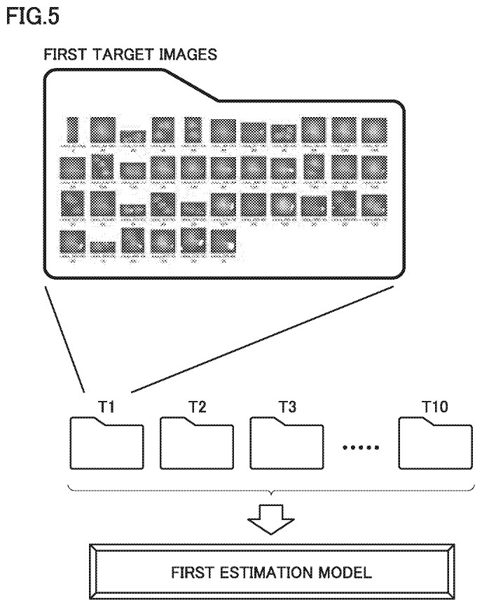

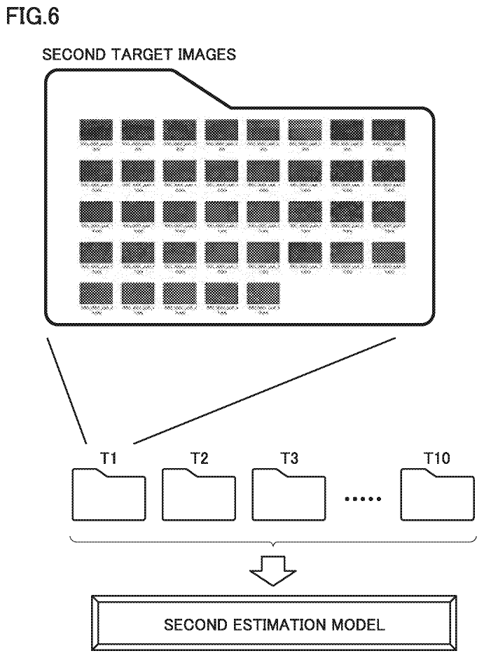

FIG. 5 is a diagram for illustrating a process of creating the first estimation model according to the embodiment. FIG. 6 is a diagram for illustrating a process of creating the second estimation model according to the embodiment.

Hereinafter, the processes of FIG. 4 will be described with reference to FIGS. 5 and 6.

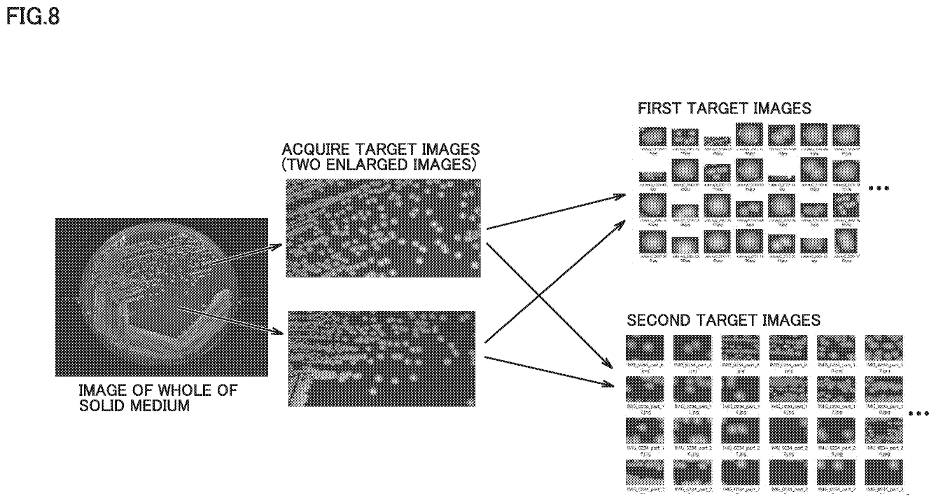

In ST01, analysis device 100 controls imaging device 16 to acquire a learning image that is an image of a solid medium on which a learning-target microorganism is cultured. The learning-target microorganism is a microorganism for which its classification is known. The learning image may be an image of a whole of the solid medium or may be one or more images including a portion of the solid medium. In one example, the learning image is an enlarged image including a portion of the solid medium. The enlarged image includes a visual feature of a colony, which is a feature intrinsic to the type of microorganism, with high resolution as compared with the image of the whole of the solid medium (see FIG. 8 described later).

In ST11, analysis device 100 creates first learning images that are images obtained by extracting portions corresponding to colonies from the learning image. In the present specification, the expression “extracting the portions corresponding to the colonies” is also referred to as “colony extraction”. Typically, analysis device 100 extracts the portions corresponding to the colonies by performing image processing on the learning image. The image processing includes, for example, binarization processing, edge detection processing, morphology processing, and the like.

In the present specification, the colony refers to a group formed by microorganisms, such as bacteria, yeasts, and molds, growing on the solid medium. Among such colonies, a colony grown from a single microorganism is referred to as a “single colony”. The single colony generally exhibits a substantially circular shape. Moreover, a plurality of such single colonies expanded and connected together accordingly are referred to as “multi-colony”. The multi-colony exhibits, for example, a shape with a plurality of circles being overlapped with each other. Colonies have different appearances depending on the types of microorganisms. More specifically, the visual features of the colonies are varied depending on types of microorganisms. Examples of the visual features known include: the size of the single colony (colony size); the height from the surface of the solid medium (i.e., the thickness of the colony); the outer shape; the unevenness of the surface; the gloss; the color; and the like. In one example, the colony size is the diameter of the single colony. The colony size may be represented by the radius, area, or the like of the single colony. Some type of microorganism causes a visual feature (for example, a pattern) around the colony. Parts of the visual features of the colony (for example, the colony size) can be represented by numerical values and are therefore also referred to as “parameters”.

In ST12, analysis device 100 performs data cleaning (first learning image cleaning) on the first learning images using a circularity of an object in each of the first learning images. The circularity is a value representing how close it is to a perfect circle. Assuming that the perfect circle is 1, the circularity is smaller in value as the shape is more complex than a circle. In other words, the first learning images obtained in ST12 are images obtained by performing, using the circularity of the object, the data cleaning on the first learning images obtained in ST11 (images obtained by extracting the portions corresponding to the colonies from the learning image).

Specifically, analysis device 100 extracts the objects (for example, the portions corresponding to the single colonies and/or the multi-colonies) included in the first learning images and performs a process of calculating the circularities of the objects. When the circularity of the object in each of the first learning images is equal to or more than a predetermined reference value, the first learning image is allowed to remain. On the other hand, when no object can be extracted from the first learning image, the first learning image is removed. Also, when the circularity of the object in the first learning image is less than the reference value, the first learning image is removed. Thus, the object having a high circularity, that is, the first learning image including the single colony can be allowed to remain, whereas the first learning image including no single colony can be removed.

In ST13, analysis device 100 creates the first estimation model by machine learning. Specifically, the first estimation model is created by performing training using, as training data, a set of the first learning images and the type of microorganism serving as the ground truth.

In ST21, analysis device 100 creates the second learning images obtained by dividing the learning image into a plurality of images each having a predetermined size. In the present specification, the expression “dividing an image into a plurality of images” includes dividing an image into a plurality of images each having a predetermined shape, and, more specifically, includes dividing an image into a plurality of images each having a predetermined shape with no clearance being interposed therebetween. An example of the predetermined shape is a quadrangular shape or a triangular shape. One example of “dividing an image into a plurality of images” is “dividing an image into the form of a matrix”.

The learning image used to create the second learning images in ST21 is typically the same image (for example, the same enlarged image) as the learning image used to create the first learning images in ST11. However, the learning image used to create the second learning images in ST21 is not necessarily the same as the learning image used to create the first learning images in ST11 as long as it is an image of the same type of microorganism cultured under the same culture condition.

In ST22, analysis device 100 performs data cleaning (second learning image cleaning) on the second learning images based on a result of edge detection of the second learning images. In other words, the second learning images obtained in ST22 are images obtained by performing, based on the result of edge detection, data cleaning on the second learning images (images obtained by dividing the learning image into a plurality of images) obtained in ST21.

Specifically, analysis device 100 performs a process of detecting a boundary (edge) of a gradation change in each of the second learning images through image processing, allows the second learning image to remain when the edge is detected, and removes the second learning image when the edge is not detected. When a colony is included in the second learning image, a surface of the colony has a gradation and an edge is detected, with the result that the second learning image is allowed to remain. Similarly, when the second learning image includes a visual feature around the colony, the second learning image is allowed to remain. On the other hand, when neither the colony nor the visual feature around the colony is included in the second learning image, that is, when only the normal surface of the solid medium is included in the second learning image, no edge is detected, with the result that the second learning image is removed.

In ST23, analysis device 100 creates the second estimation model by machine learning. Specifically, the second estimation model is created by performing training, using, as training data, a set of the second learning images and the type of microorganism serving as the ground truth.

Analysis device 100 typically performs the process of FIG. 4 for a large number of types of microorganisms. That is, ST01, ST11, ST12, ST21, and ST22 are performed for each of the large number of the types of microorganisms, thereby obtaining the first and second learning images of the large number of the types of microorganisms. Then, ST13 and ST23 are performed using the first and second learning images of the large number of the types of microorganisms, thereby obtaining the first and second estimation models for the large number of the types of microorganisms. The first and second estimation models for the large number of the types of microorganisms are stored in memory 11 and are used for a subsequent microorganism identification process.

### 4. Method for Identifying Microorganism According to Embodiment

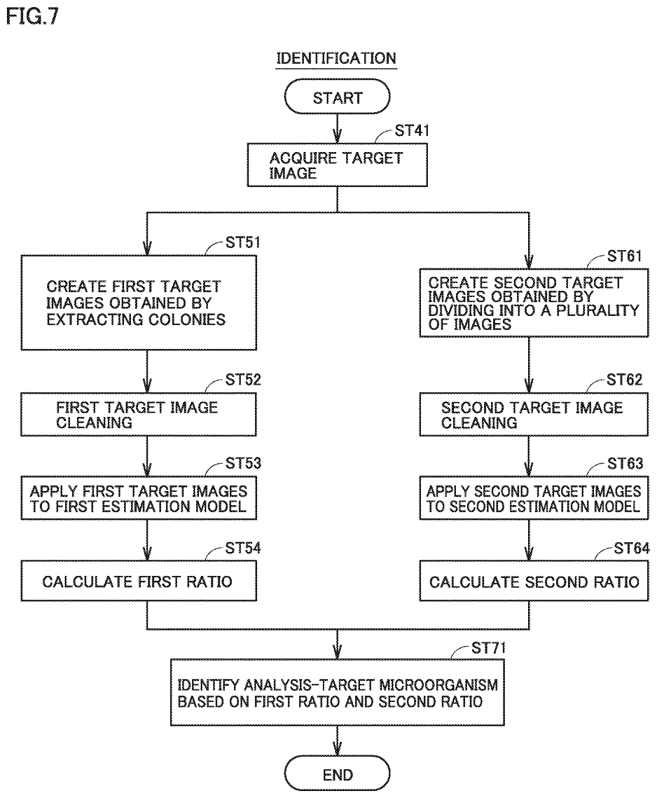

FIG. 7 is a flowchart showing the microorganism identification process according to the embodiment. Each step shown in FIG. 7 is performed by processor 10 of analysis device 100.

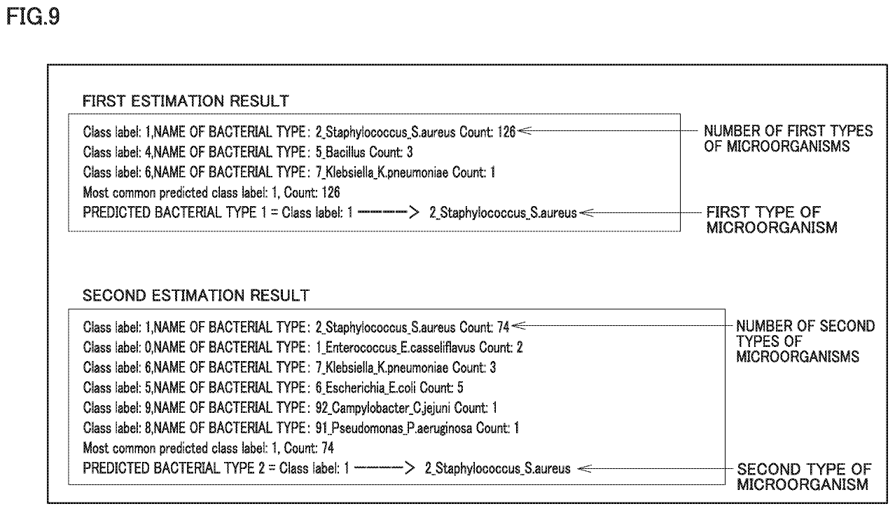

Each of FIGS. 8 and 9 is a diagram showing an example in which a microorganism is identified by applying a method for identifying a microorganism according to the embodiment to an image of a solid medium on which S. aeureus (Staphylococcus aureus) is cultured. FIG. 8 is a diagram for illustrating processes of creating the first and second target images in the example. FIG. 9 is a diagram for illustrating the first and second estimation results in the example. FIG. 9 is displayed on display 15 of analysis device 100, for example.

Hereinafter, the process of FIG. 7 will be described with reference to FIGS. 8 and 9.

In ST41, analysis device 100 controls imaging device 16 to acquire target images that are each an image of the solid medium on which the analysis-target microorganism is cultured. Each of the target images may be an image of a whole of the solid medium or one or more images including a portion of the solid medium. In one example, the target image is an enlarged image including a portion of the solid medium. The enlarged image includes a visual feature of a colony, which is a feature intrinsic to the type of microorganism, with high resolution as compared with the image of the whole of the solid medium (see FIG. 8).

In the example of FIG. 8, such target images are two enlarged images each including a portion of the solid medium. The enlarged images may be partially overlapped with each other.

In ST51, analysis device 100 creates first target images that are images obtained by extracting, from each of the target images, portions corresponding to colonies. The colony extraction is typically performed in the same manner as in ST11.

In ST52, analysis device 100 performs data cleaning (first target image cleaning) on the first target images using a circularity of an object in each of the first target images. The first target image cleaning is typically performed in the same manner as the first learning image cleaning in ST12.

In the example of FIGS. 8, 130 first target images are created from the target image.

In ST53, analysis device 100 applies the first target images to the first estimation model for estimating the type of microorganism, thereby obtaining a first estimation result.

The first estimation result includes information of a type of microorganism estimated for the first learning images. In the example of FIG. 9, the first estimation result is expressed in the form of the name of the estimated type of microorganism and the number of first learning images corresponding to the type of microorganism having the name (that is, the number of times the type of microorganism having the name is estimated).

In ST54, analysis device 100 calculates a first ratio that is a ratio of a type of microorganism included in the first estimation result. More specifically, analysis device 100 calculates a ratio (first ratio) of at least one type of microorganism among types of microorganisms included in the first estimation result. In other words, the first ratio is a ratio of at least one type of microorganism among the types of microorganisms included in the first estimation result.

In one example, analysis device 100 calculates a ratio of a type of microorganism having the highest ratio among the types of microorganisms included in the first estimation result (that is, a type of microorganism for which the number of corresponding first learning images is the largest in the first estimation result). In the example of FIG. 9, the type of microorganism having the highest ratio is S. aeureus (expressed as 2_Staphylococcus_S. aeureus in FIG. 9). Since the ratio of S. aeureus included in the first estimation result is a ratio of the “number (126) of the images corresponding to S. aeureus” to the “total number (130) of the first learning images”, analysis device 100 calculates as follows: 126/130=0.967. That is, 96.7% of the first learning images are estimated to be images of S. aeureus.

In ST61, analysis device 100 creates second target images obtained by dividing the target image into a plurality of images. The dividing is performed, for example, in the same manner as in ST21.

In ST62, analysis device 100 performs data cleaning on the second target images (second target image cleaning) based on a result of edge detection of the second target image. The second target image cleaning is typically performed in the same manner as the second learning image cleaning in ST22.

In the example of FIGS. 8, 86 second target images are obtained in the following manner: each of the target images is divided into 8×6 to acquire 96 second target images, and then 10 images in each of which no edge is detected are removed.

In ST63, analysis device 100 applies the second target images to the second estimation model for identifying the type of microorganism, thereby obtaining a second estimation result.

The second estimation result includes information of a type of microorganism estimated for the second learning images. In the example of FIG. 9, the second estimation result is expressed in the form of the name of the estimated type of microorganism and the number of second learning images corresponding to the type of microorganism having the name (that is, the number of times the type of microorganism having the name is estimated).

In ST64, analysis device 100 calculates a second ratio that is a ratio of a type of microorganism included in the second estimation result. More specifically, analysis device 100 calculates a second ratio that is a ratio of at least one type of microorganism among types of microorganisms included in the second estimation result. In other words, the second ratio includes a ratio of at least one type of microorganism among the types of microorganisms included in the second estimation result.

In one example, analysis device 100 calculates a ratio of a type of microorganism having the highest ratio among the types of microorganisms included in the second estimation result (that is, a type of microorganism for which the number of corresponding second learning images is the largest in the second estimation result). In the example of FIG. 9, the type of microorganism having the highest ratio is S. aeureus. Since the ratio of S. aeureus included in the second estimation result is a ratio of the “number (74) of images corresponding to S. aeureus” to the “total number (86) of second learning images”, analysis device 100 calculates as follows: 174/86=0.860. That is, 86.0% of the second learning images are estimated to be images of S. aeureus.

In ST71, analysis device 100 identifies the analysis-target microorganism based on the first ratio and the second ratio.

In one example, ST71 includes: a step of determining, as a first type of microorganism, a type of microorganism having the highest ratio in the first estimation result; a step of determining, as a second type of microorganism, a type of microorganism having the highest ratio in the second estimation result; and a step of identifying the analysis-target microorganism as the first type of microorganism when the ratio of the first type of microorganism is larger, and identifying the analysis-target microorganism as the second type of microorganism when the ratio of the second type of microorganism is larger.

The higher ratio of the first type of microorganism in the first estimation result means that the ground truth of the type of the analysis-target microorganism is highly likely to be the first type of microorganism. The higher ratio of the second type of microorganism in the second estimation result means that the ground truth of the type of analysis-target microorganism is highly likely to be the second type of microorganism. Therefore, by comparing the ratio of the first type of microorganism with the ratio of the second type of microorganism and using the type of microorganism having the larger ratio as the identification result, the type of microorganism that is highly likely to be the ground truth can be used as the identification result. This makes it possible to obtain an identification result that is more likely to be true, i.e., that is more reliable than that when only one of the first estimation result and the second estimation result is used.

In the example of FIG. 9, analysis device 100 determines, as the first type of microorganism, S. aeureus, which is the type of microorganism for which the number of corresponding first learning images is the largest, in the first estimation result. The ratio of the first type of microorganism is 96.7% as described above.

Similarly, analysis device 100 determines, as the second type of microorganism, S. aeureus, which is the type of microorganism for which the number of corresponding second learning images is the largest in the second estimation result. The ratio of the second type of microorganism is 86.0% as described above.

Since the ratio of the first type of microorganism (96.7%) is larger than the ratio of the second type of microorganism (86.0%), analysis device 100 identifies the analysis-target microorganism as the first type of microorganism. That is, analysis device 100 employs the first estimation result using the first estimation model based on the first learning images having been subjected to colony extraction.

As described above, in the example, as a result of using the method for identifying the microorganism according to the embodiment, the analysis-target microorganism can be correctly identified based on the first estimation result. It should be noted that the first estimation result is employed in the example, but 86.0% of the second target images are also estimated to be S. aeureus, which serves as the ground truth, in the second estimation result. Therefore, it can be said that the type of microorganism serving as the ground truth can be estimated not only by the first estimation model but also by the second estimation model.

### 5. Supplementary Explanation for Images Used in Embodiments

In ST01, preferably, images of microorganisms cultured under the same culture condition are used as the learning images. The culture condition includes a culture temperature, a culture time, and/or a composition of a medium. Similarly, in ST41, images of microorganisms cultured under the same culture condition as that for the learning-target microorganism are preferably used as the target images. Thus, it is possible to suppress a difference between the visual features of the colonies (for example, a difference between the colony sizes) due to the culture condition from being reflected in the learning data and becoming a factor for misidentification of the microorganism.

In each of ST11 and ST51, the size of a window for extracting the colony is preferably set to be variable within a predetermined size range. The predetermined size range is such a size range that a sufficient number of colonies can be extracted from the learning image or the target image. By setting the size of the window to be variable, a window matching the colony size corresponding to the type of microorganism is set, with the result that a single colony can be appropriately extracted even with regard to types of microorganisms having different colony sizes.

In the embodiment, ST12 is not essential; however, by performing ST12, only the high-quality first learning images including the homogeneous data, i.e., the single colonies can be used for the machine learning. In other words, high-quality learning data can be created. Thus, the first estimation model having high quality can be created.

In addition, even in solid media in which the same type of microorganism is cultured under the same culture condition, the parameters such as the colony size, height, and outer shape of the multi-colony are varied depending on the positions or the like of the single colonies from which the multi-colony is formed, but the parameters of the single colonies are relatively homogeneous. Therefore, it can be said that the first learning image including the single colony is high-quality learning data that securely includes the parameters intrinsic to the type of microorganism.

For a first learning image including a single colony, a colony size can be calculated. Therefore, it is possible to identify a microorganism in consideration of the colony size (see a modification described later).

Similarly, in the embodiment, ST52 is not essential; however, by performing ST52, only the first target image including the homogeneous data, i.e., the single colony can be allowed to remain. Therefore, when ST52 is performed, it is possible to obtain the first estimation result with higher precision than that when ST52 is not performed.

Moreover, in the embodiment, ST22 is not essential; however, by performing ST22, it is possible to remove a second learning image that includes no colony and no visual feature around the colony (that is, a second learning image in which only the solid medium is captured), and use only an image that includes at least one of the colony and the visual feature around the colony. In other words, high-quality learning data including only the second learning image including the feature of the type of microorganism can be created. Thus, the second estimation model having high quality can be created.

Similarly, in the embodiment, ST62 is not essential; however, by performing ST62, only the second target image including the feature of the type of microorganism can be allowed to remain. Therefore, when ST62 is performed, it is possible to obtain the second estimation result with higher precision than that when ST62 is not performed.

### 6. Comparison with Conventional Method for Identifying Microorganism

In a clinical microbial test performed in a clinical laboratory or the like, in order to determine a treatment policy for a patient, microorganisms included in a sample derived from the patient are cultured so as to estimate or identify types of microorganisms. Examples of known methods for estimating or identifying types of microorganisms include Gram stain, biochemical characterization, MALDI-MS, and the like. However, a skilled laboratory technician familiar with a visual feature of a colony for each type of microorganism can generally estimate a type of microorganism simply by observing colonies cultured in a solid medium in consideration of patient information, culture condition, and the like.

Moreover, in the microorganism identification, it is preferable to comprehensively consider not only a result obtained by one method but also results obtained by a plurality of methods. Therefore, even at the present time when the above-described methods have been developed, the estimation of a type of microorganism by a visual feature of a colony is important.

However, it takes a considerable time to train a skilled laboratory technician who is familiar with a visual feature of a colony for each type of microorganism and who can estimate a type of microorganism by observing the colony. Moreover, in many cases, it is difficult to secure a human resource for training a laboratory technician to be a skilled laboratory technician. As a result, actually in many sites, it is difficult to secure a skilled laboratory technician. Further, in general, even a laboratory technician skilled in a certain technical field is often not familiar with a visual feature of a type of microorganism that the laboratory technician does not see routinely and/or a type of microorganism falling out of the technical field.

In view of such a circumstance, attempts have been made to estimate a type of microorganism from images of colonies by performing machine learning on an AI (Artificial Intelligence) using images of colonies of microorganisms as in Fan Yang et al., and Osamu Hasegawa, et al., above; however, they have not been put into practical use. This is because appearances of colonies varies depending on respective types of microorganisms and there are a large number of, i.e., several thousands of types of analysis-target microorganisms.

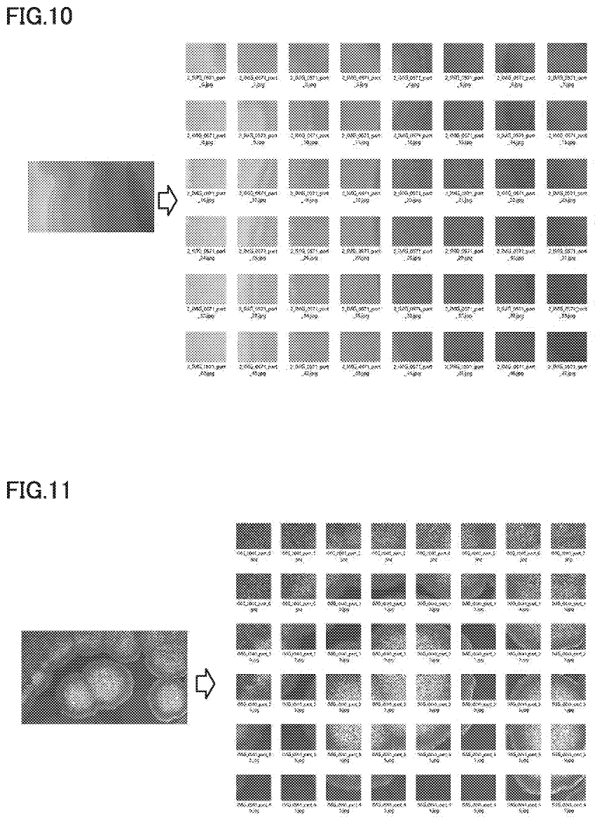

For example, in the image of FIG. 8, the edge of the colony (that is, the boundary between a portion at which a large amount of microorganism is present and a portion at which no microorganism is considered to be present) is clear, and the colony extraction can be performed. However, a type of microorganism in FIG. 10 exhibit a gradation pattern in which an amount of microorganism is gradually varied depending on a distance. That is, since no colony having a clear edge is formed, it is difficult to perform the colony extraction. Therefore, the type of microorganism in FIG. 10 cannot be handled by the techniques of Fan Yang et al., and Osamu Hasegawa, et al., above because the colony extraction cannot be performed.

Further, a type of microorganism in FIG. 11 also has a huge colony size. Specifically, only a small number (for example, several) of huge colonies are formed on a solid medium in a petri dish generally used to culture a microorganism. Therefore, it is difficult to detect such a huge colony by the technique of extracting a colony included in a divided image of the solid medium as in Fan Yang et al., and Osamu Hasegawa, et al., above. Moreover, even when one attempts to directly extract the huge colonies from the image of the whole of the solid medium, the number of the colonies is too small and therefore may be insufficient as learning data.

On the other hand, according to the present embodiment, both the type of microorganism in FIG. 10 and the type of microorganism in FIG. 11 can be handled by the second estimation model that does not require the colony extraction.

It should be noted that similarly, a colony having become too large due to over-culturing can also be identified using the second estimation model.

Moreover, some type of microorganism may cause a visual feature around a colony. For example, some type of hemolytic microorganism causes a pattern called “hemolytic ring” around a colony. Since the second learning image used to train the second estimation model also includes the surroundings of the colony, the type of microorganism can be determined in consideration of the visual feature of the surroundings of the colony according to the second estimation model.

As described above, in the embodiment, the first estimation result and the second estimation result can be obtained respectively by using the first estimation model focusing on the visual feature of the colony having the general size as shown in FIG. 8 and the second estimation model focusing on the wider range of the visual features derived from the types of microorganisms as shown in FIGS. 10 and 11. From the first estimation result and the second estimation result, a more reliable estimation result (in other words, an estimation result that is more likely to be a ground truth) can be selected as the identification result. As described above, according to the embodiment, it is possible to provide a method by which types of microorganisms having various appearances can be identified with high precision.

In particular, since the more reliable estimation result is automatically selected from the first estimation result and the second estimation result in the present embodiment, several thousands of types of microorganisms having several thousands of variations of appearances can be handled.

For example, although each of FIGS. 10 and 11 shows the example in which the appearance is extremely different from that in FIG. 8, there is a microorganism having an appearance between one of the appearances in FIGS. 10 and 11 and the appearance in FIG. 8, and in this case, it is not easy for a human to determine which one of the first estimation model and the second estimation model should be used to obtain a more reliable estimation result. Moreover, it is not easy to define the several thousands of the variations of appearances by a common parameter.

However, according to the present embodiment, the estimation result of the estimation model by which the type of microorganism is considered to be able to be more precisely estimated is automatically selected from the first estimation model and the second estimation model. Therefore, even though a laboratory technician does not review by which one of the first estimation model and the second estimation model the type of microorganism can be more precisely estimated with regard to the analysis-target microorganism, an appropriate estimation model can be automatically selected and an optimal identification result can be obtained.

Summarizing the above, according to the embodiment, since the AI, rather than the human, can appropriately identify microorganisms that form colonies of various appearances, it is possible to readily identify a wide variety of types of microorganisms. Therefore, by introducing the analysis device for performing the method for identifying the microorganism according to the embodiment, it is possible to identify a type of microorganism based on a visual feature of a colony even in a clinical laboratory without a skilled laboratory technician. In particular, by using the AI, a large number of microorganisms derived from a large number of samples can be identified in a short time.

### 7. Modification

In a method for identifying a microorganism according to a modification, the microorganism is identified in consideration of the colony size of the type of microorganism obtained in the first estimation result.

In the microorganism identification process according to the modification, the processes of ST01 and ST71 are different from those in the microorganism identification process according to the embodiment.

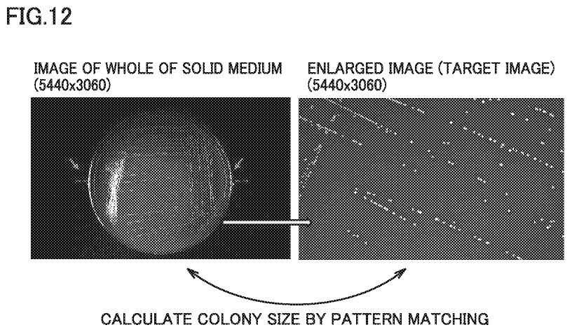

In ST01 of the modification, analysis device 100 acquires an image of a whole of a solid medium on which a microorganism is cultured and an enlarged image (target image) (see FIG. 12).

In ST71 of the modification, analysis device 100 includes: (i) a step of calculating a corrected ratio obtained by correcting the first ratio with a correction coefficient based on a colony size stored for each type of microorganism and a colony size of the target image; and (ii) a step of identifying an analysis-target microorganism based on the corrected ratio and the second ratio.

### (7-1. Process As Preparation for Step (i))

In one example of ST01 of the modification, imaging device 16 captures the image of the whole of the solid medium using a lens with a low magnification, and captures the enlarged image using a lens with a high magnification.

Next, analysis device 100 performs pattern matching between the image of the whole and the enlarged image so as to determine which range in the image of the whole the enlarged image corresponds to.

Further, the analysis device calculates a colony size (for example, the diameter of the single colony) in the enlarged image by using the range and the size (for example, diameter) of the Petri dish stored in memory 11 in advance.

In one example, with actual diameter Ds of the petri dish, the number of pixels Ps corresponding to the diameter of the petri dish in the image of the whole, long side Li of the range corresponding to the enlarged image in the image of the whole, the number of pixels Pi of the long side of the enlarged image, and the number of pixels Pm corresponding to the diameter of the single colony in the enlarged image, actual diameter Dm of the single colony is calculated as follows: Dm=(Ds×Li×Pm)/(Ps×Pi). A reason therefor will be described below.

The actual length corresponding to one pixel in the image of the whole is Ds/Ps. Therefore, the actual length corresponding to the long side of the enlarged image is (Ds/Ps)×Li.

Therefore, the actual length corresponding to one pixel in the enlarged image is {(Ds/Ps)×Li}×(1/Pi)=(Ds×Li)/(Ps×Pi).

Therefore, actual diameter Dm of the single colony={(Ds×Li)/(Ps×Pi)}Pm=(Ds×Li×Pm)/(Ps×Pi).

In the example of FIG. 12, each of the image of the whole and the enlarged image is 5440×3060 pixels. The actual diameter of the Petri dish is 90 mm and the number of pixels corresponding to the diameter of the Petri dish in the image of the whole is 2748 pixels.

Therefore, the size of one pixel in the image of the whole is 90 mm/2748=0.033 mm. Here, since the long side of the range corresponding to the enlarged image in the image of the whole is 974 pixels, the actual length corresponding to the long side of the enlarged image is 0.033×974 pixels.

Therefore, since the actual length corresponding to one pixel in the enlarged image is (the actual length corresponding to the long side of the enlarged image)/(the number of pixels of the long side of the enlarged image), (0.033×974)/5440=0.033/5.59=0.0059 mm.

Therefore, the actual diameter of the single colony is a value obtained by multiplying, by 0.0059 mm, the number of pixels Pm corresponding to the single colony in the enlarged image.

(7-2. Steps (i) and (ii))

Next, a first correction method and a second correction method, which are specific examples of the steps (i) and (ii), will be described.

### (7-2-1. First Correction Method)

The first correction method is a method in which the colony size is used in selecting the type of microorganism that is a representative of the first estimation result. As one specific example of the first correction method, consider a case where there are a plurality of types of microorganisms each having the highest ratio in the first estimation result.

For example, consider an example in which a ratio of a type of microorganism T1 is 40% and a ratio of a type of microorganism T2 is 40% in the first estimation result. Memory 11 stores such a fact that the colony size of the type of microorganism T1 is 1 μm on average and the colony size of the type of microorganism T2 is 4 μm on average. On the other hand, the colony size of the analysis-target microorganism is 4 μm on average.

Next, analysis device 100 corrects the ratio of the type of microorganism T1 and the ratio of the type of microorganism T2 based on the colony size registered for each type of microorganism and the colony size of the target image. Specifically, the ratio of the type of microorganism T1 with its colony size not coinciding with that of the analysis-target microorganism is multiplied by a correction coefficient α. α is a constant in a range of 0<α<1. On the other hand, the ratio of the type of microorganism T2 with its colony size coinciding with that of the analysis-target microorganism is multiplied by 1. As a result, the corrected ratio of the type of microorganism T1 is 40α%, and the corrected ratio of the type of microorganism T2 is 40%.

Then, analysis device 100 compares the corrected ratio (40α%) of the type of microorganism T1 with the corrected ratio (40%) of the type of microorganism T2, and selects the type of microorganism T2, which has the largest corrected ratio.

Then, analysis device 100 compares the corrected ratio (40%) of the type of microorganism T2 with the ratio of the second type of microorganism, and identifies the type of microorganism having the larger ratio as the type of microorganism of the analysis-target microorganism.

In this way, in the first correction method, (i) the corrected ratio is calculated by correcting the ratio of at least one type of microorganism (that is, at least one first ratio) included in the first estimation result with the correction coefficient based on the colony sizes stored for each type of microorganism and the colony size of the target image. (ii) The type of microorganism having the highest corrected ratio is determined as the corrected first type of microorganism. Then, the ratio of the corrected first type of microorganism and the ratio of the second type of microorganism are compared, the analysis-target microorganism is identified as the corrected first type of microorganism when the ratio of the corrected first type of microorganism is larger, and the analysis-target microorganism is identified as the second type of microorganism when the ratio of the second type of microorganism is larger.

As described above, according to the first method, even when there are a plurality of types of microorganisms each having the largest ratio in the first estimation result, a type of microorganism having a colony size closer to the analysis-target microorganism can be selected as a representative of the first estimation result. In other words, by referring to the colony size, a more reliable type of microorganism can be selected as the representative of the first estimation result.

Next, another implementation of the first method will be described.

In the first method, in the first estimation result, the ratio of the type of microorganism other than the type of microorganism having the largest ratio may also be corrected. For example, in the first estimation result, the ratio of the type of microorganism whose ratio is equal to or more than the predetermined % may be set to be corrected, or the ratio of the type of microorganism whose difference of the ratio from the ratio of the type of microorganism having the largest ratio is equal to or less than a predetermined % may be set to be corrected.

The correction coefficient is not a constant, and may be a variable set based on the colony size stored for each type of microorganism and the colony size of the target image. The variable is set to be a smaller value (is set to be inversely proportional) as the difference between the colony size stored for each type of microorganism and the colony size of the target image is larger.

### (7-2-2. Second Correction Method)

The second correction method is a method that uses the colony size when comparing the ratio of the first type of microorganism and the ratio of the second type of microorganism. As a specific example of the second correction method, consider a case where the ratio of the first type of microorganism and the ratio of the second type of microorganism are the same. For example, consider an example in which the ratio of the first type of microorganism is 40% and the ratio of the second type of microorganism is 40%. Memory 11 stores such a fact that the colony size of the first type of microorganism is 1 μm on average. On the other hand, the colony size of the analysis-target microorganism is 4 μm on average.

Next, analysis device 100 corrects the ratio of the first type of microorganism based on the colony size registered for each type of microorganism and the colony size of the target image. Specifically, the ratio of the first type of microorganism having a colony size that does not coincide with that of the analysis-target microorganism is multiplied by a correction coefficient α. α is a constant in the range of 0<α<1. As a result, the corrected ratio of the first type of microorganism is 40α%.

Then, analysis device 100 compares the corrected ratio (40α%) of the first type of microorganism with the ratio (40%) of the second type of microorganism, and selects, as the identification result, the second type of microorganism having the larger ratio.

As described above, in the second correction method, (i) based on the colony size stored for each type of microorganism and the colony size of the target image, the corrected ratio is calculated by correcting the ratio of the first type of microorganism by the correction coefficient. (ii) The corrected ratio of the first type of microorganism and the ratio of the second type of microorganism are compared, the analysis-target microorganism is identified as the first type of microorganism when the corrected ratio of the first type of microorganism is larger, the analysis-target microorganism is identified as the second type of microorganism when the ratio of the second type of microorganism is larger.

As described above, according to the second method, even in the case where the ratio of the first type of microorganism and the ratio of the second type of microorganism coincide with each other, when the colony size of the first type of microorganism is different from the colony size of the analysis-target microorganism, the first type of microorganism can be selected as the identification result. In other words, by referring to the colony size, a more reliable type of microorganism can be identified.

Next, another implementation of the second method will be described.

In the second method, in addition to the case where the ratio of the first type of microorganism and the ratio of the second type of microorganism coincide with each other, the correction by the colony size may be set to be performed also in the case where the ratio of the first type of microorganism and the ratio of the second type of microorganism are values relatively close to each other. For example, the ratio of the first type of microorganism may be corrected when both the ratio of the first type of microorganism and the ratio of the second type of microorganism are each equal to or more than the predetermined % or when the difference between the ratio of the first type of microorganism and the ratio of the second type of microorganism is equal to or less than the predetermined %.

The correction coefficient is not a constant, and may be a variable set based on the colony size stored for each type of microorganism and the colony size of the target image. The variable is set to be a smaller value (is set to be inversely proportional) as the difference between the colony size stored for each type of microorganism and the colony size of the target image is larger.

### 8. Other Implementations

The embodiments and modifications can also be used to inspect introduction (contamination) of a type of microorganism other than the type of analysis-target microorganism onto the solid medium.

For example, in the case where it is possible to predict, in advance, a specific type of microorganism that is highly likely to cause contamination and it is considered that the type of analysis-target microorganism is not the specific type of microorganism, it is considered that there is a high possibility that contamination has occurred when the specific type of microorganism is included in the first estimation result and/or the second estimation result. The specific type of microorganism is, for example, a type of microorganism that resides in an environment of a clinical laboratory including a laboratory technician and that is considered to be likely to cause contamination. The type of analysis-target microorganism is, for example, a type of microorganism that is not normally present in the environment.

Moreover, for example, in the case where there is a type of microorganism clearly far from the other types of microorganisms in terms of phylogenetic classification among the types of microorganisms included in the first estimation result and/or the second estimation result, it is considered that the type of microorganism far from the other types of microorganisms in terms of the phylogenetic classification may be a type of microorganism having caused the contamination.

### Implementations

It will be understood by those skilled in the art that the plurality of exemplary embodiments described above are specific examples of the following implementations.

(Item 1) A method for identifying a microorganism according to one implementation includes: acquiring a target image that is an image of a solid medium on which an analysis-target microorganism is cultured; creating first target images that are images obtained by extracting, from the target image, portions corresponding to colonies; creating second target images obtained by dividing the target image into a plurality of images; obtaining a first estimation result by applying the first target images to a first estimation model for estimating a type of microorganism; obtaining a second estimation result by applying the second target images to a second estimation model for identifying a type of microorganism; calculating a first ratio that is a ratio of the type of microorganism included in the first estimation result; calculating a second ratio that is a ratio of the type of microorganism included in the second estimation result; and identifying the analysis-target microorganism based on the first ratio and the second ratio. The first estimation model is a model trained by using, as training data, a set of first learning images and a type of microorganism serving as a ground truth, the first learning images being images obtained by extracting, from a learning image, portions corresponding to colonies, the learning image being an image of a solid medium on which a learning-target microorganism is cultured. The second estimation model is a model trained by using, as training data, a set of second learning images and the type of microorganism serving as the ground truth, the second learning images being obtained by dividing the learning image into a plurality of images.

According to the method for identifying the microorganism according to item 1, it is possible to provide a method by which types of microorganisms having various appearances can be identified with high precision.

(Item 2) In the method for identifying the microorganism according to item 1, the identifying includes determining, as a first type of microorganism, a type of microorganism having a highest ratio in the first estimation result, determining, as a second type of microorganism, a type of microorganism having a highest ratio in the second estimation result, and comparing the ratio of the first type of microorganism with the ratio of the second type of microorganism, identifying the analysis-target microorganism as the first type of microorganism when the ratio of the first type of microorganism is larger, and identifying the analysis-target microorganism as the second type of microorganism when the ratio of the second type of microorganism is larger.

According to the method for identifying the microorganism according to item 2, it is possible to obtain an identification result that is more likely to be true, that is, more reliable than that in the case of using only one of the first estimation result and the second estimation result.

(Item 3) In the method for identifying the microorganism according to item 1, the identifying includes calculating, based on a colony size stored for each type of microorganism and a colony size of the target image, a corrected ratio obtained by correcting the first ratio with a correction coefficient, and identifying the analysis-target microorganism based on the corrected ratio and the second ratio.

According to the method for identifying the microorganism according to item 3, by referring to the colony size, a more reliable type of microorganism can be selected as a representative of the first estimation result.

(Item 4) In the method for identifying the microorganism according to any one of items 1 to 3, the first learning images are images obtained by performing, using a circularity of an object, data cleaning on the images obtained by extracting the portions corresponding to the colonies from the learning image.

According to the method for identifying the microorganism according to item 4, the first estimation model having high quality can be created.

(Item 5) In the method for identifying the microorganism according to any one of items 1 to 4, the second learning images are images obtained by performing, based on a result of edge detection, data cleaning on the images obtained by dividing the learning image into the plurality of images.

According to the method for identifying the microorganism according to item 5, the second estimation model having high quality can be created.

(Item 6) In the method for identifying the microorganism according to any one of items 1 to 5, the creating the first target images includes performing data cleaning on the first target images using a circularity of an object in each of the first target images.

According to the method for identifying the microorganism according to item 6, it is possible to obtain the first estimation result having high precision.

(Item 7) In the method for identifying the microorganism according to any one of items 1 to 6, the creating the second target images includes performing data cleaning on the second target images based on a result of edge detection of the second target images.

According to the method for identifying the microorganism according to item 7, it is possible to obtain the second estimation result with high precision.

(Item 8) An analysis device for identifying a microorganism includes: a processor that performs the method for identifying the microorganism according to any one of items 1 to 7; and a memory that stores the first estimation model and the second estimation model.

According to the analysis device according to item 8, it is possible to provide a method by which types of microorganisms having various appearances can be identified with high precision.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A method for identifying a microorganism, the method comprising:
acquiring a target image that is an image of a solid medium on which an analysis-target microorganism is cultured;
creating first target images that are images obtained by extracting, from the target image, portions corresponding to colonies;
creating second target images obtained by dividing the target image into a plurality of images;
obtaining a first estimation result by applying the first target images to a first estimation model for estimating a type of microorganism;
obtaining a second estimation result by applying the second target images to a second estimation model for identifying a type of microorganism;
calculating a first ratio that is a ratio of the type of microorganism included in the first estimation result;
calculating a second ratio that is a ratio of the type of microorganism included in the second estimation result; and
identifying the analysis-target microorganism based on the first ratio and the second ratio, wherein
the first estimation model is a model trained by using, as training data, a set of first learning images and a type of microorganism serving as a ground truth, the first learning images being images obtained by extracting, from a learning image, portions corresponding to colonies, the learning image being an image of a solid medium on which a learning-target microorganism is cultured, and
the second estimation model is a model trained by using, as training data, a set of second learning images and the type of microorganism serving as the ground truth, the second learning images being obtained by dividing the learning image into a plurality of images.

2. The method for identifying the microorganism according to claim 1, wherein
the identifying includes
determining, as a first type of microorganism, a type of microorganism having a highest ratio in the first estimation result,
determining, as a second type of microorganism, a type of microorganism having a highest ratio in the second estimation result,
comparing the ratio of the first type of microorganism with the ratio of the second type of microorganism,
identifying the analysis-target microorganism as the first type of microorganism when the ratio of the first type of microorganism is larger, and
identifying the analysis-target microorganism as the second type of microorganism when the ratio of the second type of microorganism is larger.

3. The method for identifying the microorganism according to claim 1, wherein
the identifying includes
calculating, based on a colony size stored for each type of microorganism and a colony size of the target image, a corrected ratio obtained by correcting the first ratio with a correction coefficient, and
identifying the analysis-target microorganism based on the corrected ratio and the second ratio.

4. The method for identifying the microorganism according to claim 1, wherein the first learning images are images obtained by performing, using a circularity of an object, data cleaning on the images obtained by extracting the portions corresponding to the colonies from the learning image.

5. The method for identifying the microorganism according to claim 1, wherein the second learning images are images obtained by performing, based on a result of edge detection, data cleaning on the images obtained by dividing the learning image into the plurality of images.

6. The method for identifying the microorganism according to claim 1, wherein
the creating the first target images includes
performing data cleaning on the first target images using a circularity of an object in each of the first target images.

7. The method for identifying the microorganism according to claim 1, wherein
the creating the second target images includes
performing data cleaning on the second target images based on a result of edge detection of the second target images.

8. An analysis device for identifying a microorganism, the analysis device comprising:
a processor that performs the method for identifying the microorganism according to claim 1; and
a memory that stores the first estimation model and the second estimation model.
